(19) United States
(12) Patent Application Publication
(10) Pub. No.: US 2026/0169324 A1
(43) Pub. Date: Jun. 18, 2026

(54) Integrated Display Device Cabinet Door

(71) Applicant: Textron Aviation Inc., Wichita, KS (US)

(72) Inventors: Patrick Allen Stanton, Rose Hill, KS (US); Adam Ryan Payton, Haysville, KS (US); Jason Eric Francis, Kingman, KS (US); Grace Ellen Magnasco, Maize, KS (US); Blake David Raybern, Wichita, KS (US)

(21) Appl. No.: 18/979,883

(22) Filed: Dec. 13, 2024

(51) Int. Cl. G02F 1/1333; A47B 81/00; B64D 11/04

(52) U.S. Cl. CPC G02F 1/133308; A47B 81/00; B64D 11/04

(57) ABSTRACT

An integrated display device cabinet door includes a cabinet door for supporting a display device. The door includes a device frame which holds the display device in the door and fits between an outer shell and backing panel. A channel is formed into the door, which receives wiring from the display device and provides a path for the wiring to be carried away from the display device and out of the door. The door includes an opening, which exposes the screen of the display device on a façade of the cabinet door.

### BACKGROUND OF THE INVENTION

The disclosed embodiments relate generally to the field of aircraft interiors. More specifically, embodiments herein relate to cabinet doors and display screens.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages will be apparent from the following detailed description of the embodiments and the accompanying drawing figures.

In some embodiments, the techniques described herein relate to an integrated display device cabinet door including: an outer shell including an opening configured to reveal a display, wherein the outer shell is configured to pivot relative to a cabinet housing; a device frame configured to insert into the outer shell and support the display in the outer shell, wherein the device frame is configured to align the display within the opening; and a channel formed into the outer shell, wherein the channel is configured to receive wiring from the display and provide a path for the wiring to exit out of the outer shell.

In some embodiments, the techniques described herein relate to a cabinet door including a backing panel configured to provide a backing for the cabinet door.

In some embodiments, the techniques described herein relate to a cabinet door wherein the backing panel includes an outlet hole substantially aligned with an air outlet of the display, wherein the outlet hole allows air exchange through the backing panel.

In some embodiments, the techniques described herein relate to a cabinet door wherein the outer shell includes a main portion and an angled portion which is angled relative to the main portion.

In some embodiments, the techniques described herein relate to a cabinet door wherein the channel is formed into the main portion and the angled portion of the outer shell, and a portion of the channel is angled to match the angle of the angled portion.

In some embodiments, the techniques described herein relate to a cabinet door wherein the angled portion of the channel is configured to increase a bend radius of the cabinet door relative to the cabinet housing thereby mitigating damage to the wiring by allowing the wiring to be bent gradually when the cabinet door is opened and closed.

In some embodiments, the techniques described herein relate to a cabinet door including a cover plate mounted to the angled portion and configured to cover the opening of the channel.

In some embodiments, the techniques described herein relate to a cabinet door wherein the cover plate includes a slot, the slot being configured to receive the wiring for exiting the channel.

In some embodiments, the techniques described herein relate to a cabinet door including hinges mounted to the outer shell and the cabinet housing, wherein the hinges are configured to allow the cabinet door to open and close relative to the cabinet housing.

In some embodiments, the techniques described herein relate to a cabinet door wherein the hinges are an overlay type of hinge configured to increase a swing radius when the cabinet door is opened and closed.

In some embodiments, the techniques described herein relate to an integrated display device cabinet door including: a cabinet door having an outer shell configured to form an outer structure of the cabinet door, wherein the outer shell includes: a device frame configured to support a display, wherein the device frame includes an opening positioned to align with the display when supported in the device frame; and a backing panel, wherein the device frame is sandwiched between the backing panel and an inner portion of the outer shell a cover plate configured to cover a channel formed in the outer shell, wherein the channel includes an entrance positioned near the device frame and an exit positioned away from the device frame, such that wiring from the display is received by the channel and routed away from the display and out of the outer shell.

In some embodiments, the techniques described herein relate to a cabinet door wherein the backing panel includes tabbed ends having an offset from a main body of the backing panel, wherein the tabbed ends are configured to fasten to the device frame.

In some embodiments, the techniques described herein relate to a cabinet door wherein the offset of the tabbed ends allows for the main body to be spaced away from the display such that the channel is configured to receive the wiring.

In some embodiments, the techniques described herein relate to a cabinet door wherein the outer shell includes an outer wall and the display is pressed up directly against the outer wall when supported by the device frame, such that the display is substantially flush mounted with the outer shell.

In some embodiments, the techniques described herein relate to a cabinet door wherein the backing panel includes a plurality of inlet holes which allow for air to circulate against the display behind the backing panel.

In some embodiments, the techniques described herein relate to a cabinet door wherein the display is a user interface device.

In some embodiments, the techniques described herein relate to a cabinet door wherein the user interface device is a touchscreen interface.

In some embodiments, the techniques described herein relate to a cabinet door wherein the device frame includes a forward portion and a wall portion configured to contact the display and support the display within the device frame.

In some embodiments, the techniques described herein relate to a cabinet door wherein the cover plate includes a slot configured for the wiring to exit the channel.

In some embodiments, the techniques described herein relate to a cabinet door including a structural bracket positioned against an outer surface of the cover plate wherein the structural bracket has an outer slot which aligns with the slot of the cover plate.

### BRIEF DESCRIPTION OF THE SEVERAL VIEWS OF THE DRAWINGS

Illustrative embodiments are described in detail below with reference to the attached drawing figures, which are incorporated by reference herein and wherein:

FIG. 1A is a perspective view of an integrated display device cabinet door with a touchscreen display mounted to a cabinet housing in accordance with embodiments of the present disclosure;

FIG. 1B is a perspective view of the integrated display device cabinet door of FIG. 1A with the touchscreen display removed;

FIG. 2A is a front perspective view of the integrated display device cabinet door of FIG. 1A;

FIG. 2B is a back perspective view of the integrated display device cabinet door of FIG. 1A;

FIG. 3 is a cross-sectional view taken along the line 2-2 of the integrated display device cabinet door of FIG. 1A;

FIG. 4A is a close-up perspective view revealing a channel of the integrated display device cabinet door of FIG. 1A;

FIG. 4B is a close-up perspective view of the channel of FIG. 4A covered by a cover plate;

FIG. 5A is a perspective view of the integrated display device cabinet door of FIG. 1A in an open position relative to the cabinet housing; and

FIG. 5B is another perspective view of the integrated display device cabinet door of FIG. 1A in an open position relative to the cabinet housing.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the technology can include a variety of combinations and/or integrations of the embodiments described herein.

Embodiments disclosed herein provide a system and a method for having an integrated display device cabinet door. Aircraft cabin management systems oftentimes require advanced methods of executing control and can have complex menus and advanced controls. This often requires increasing the size of aircraft cabin management control panels to facilitate the advanced control functionality of aircraft systems. A system is needed to integrate the control panel with a cabinet door which does not impact the storage capacity of the cabinet or container. The integrated display device cabinet door is configured for a display such as a user interface device to be embedded into a cabinet door without impacting the functionality of the door and the accessibility of the panel. The cabinet door is configured to house the display so that the storage space of the cabinet or container is preserved. In embodiments, the display can be a user interface device configured to provide control for an aircraft cabin system. The cabinet door includes a frame which allows the display or interface device to be held in the door with the interfacing surface being directed outwards and positioned for access to a user. A back panel of the door is configured to have heat dissipation allowing air to circulate in and out of the back panel to substantially prevent the display from overheating. A channel is formed into the door near the frame which allows for wiring from the interface panel (not shown) to be directed and received into the channel which carries the wiring away from the device frame and out of the cabinet door.

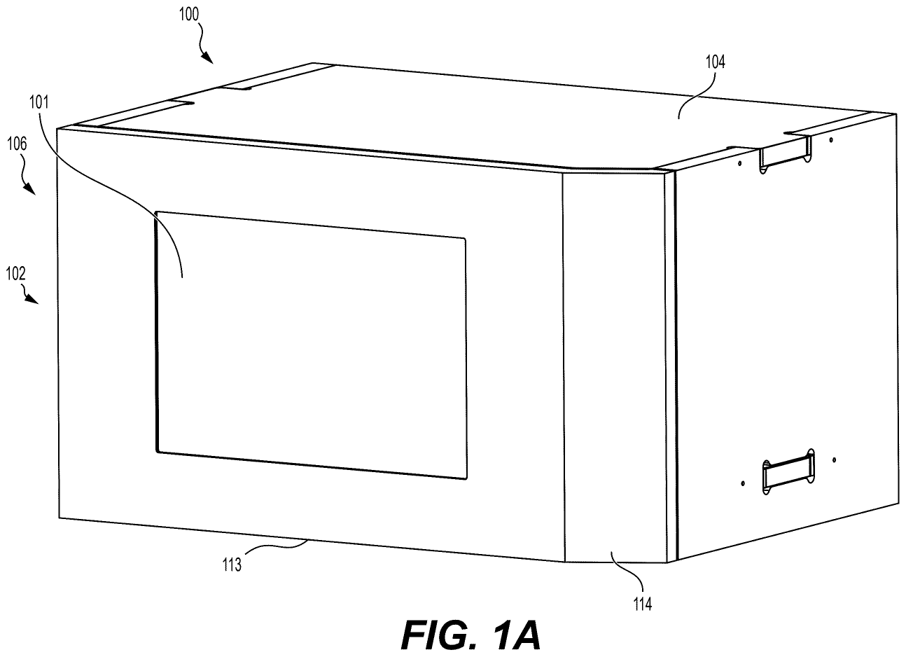

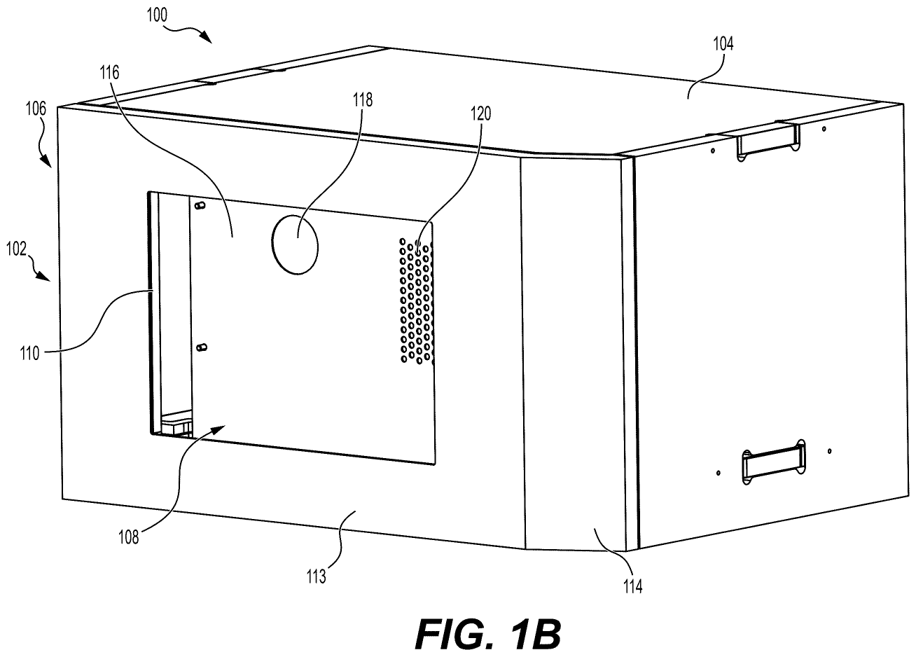

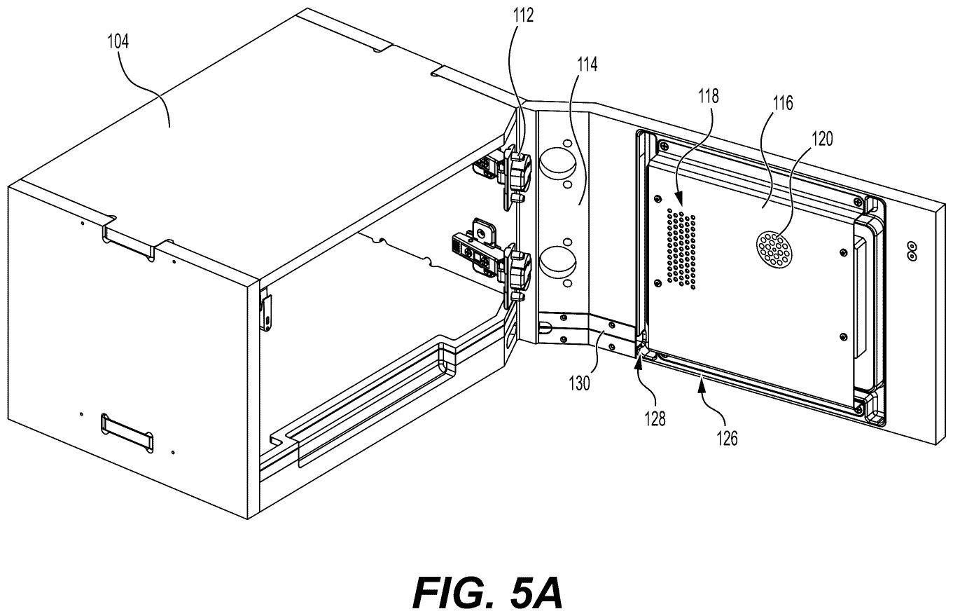

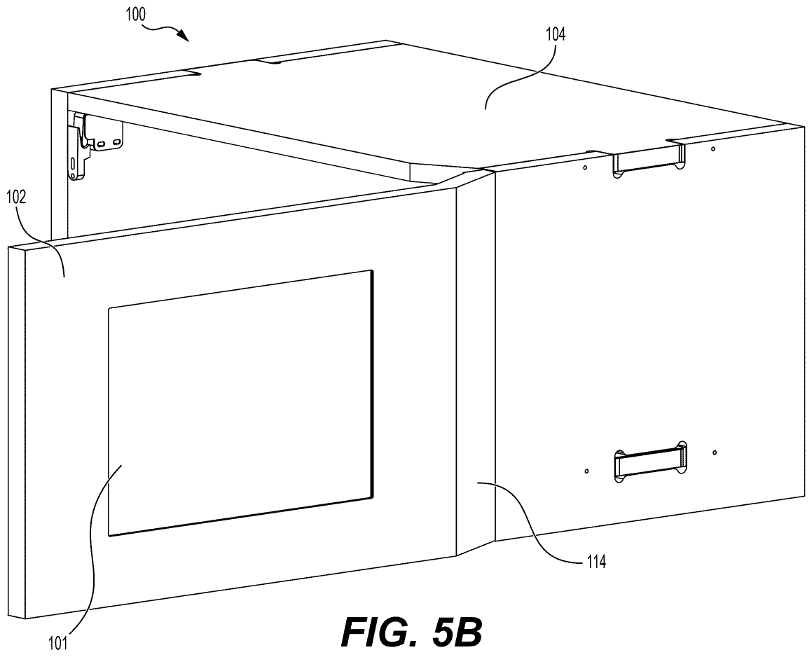

With reference to FIGS. 1A-5B, and the following description an integrated display device cabinet door 102 is shown and described. FIG. 1A shows a cabinet 100 having the integrated display device cabinet door 102 mounted to a cabinet housing 104. The cabinet housing 104 includes an internal storage space within housing 104 which is accessible when the door 102 is opened (shown in FIGS. 5A and 5B). The cabinet 100 can be a container, cupboard, or another interior monument having a housing and internal volume accessible using a door. The cabinet 100 may be a standalone unit as shown or may be configured as part of an aircraft galley or cabinet arrangement. The door 102 includes an outer shell 106 which can match up substantially flush against the side panels of housing 104 when the door 102 is closed as shown in FIGS. 1A and 1B. The outer shell 106 includes an opening 108 substantially positioned in the center of a main portion 113 which can reveal the display 101 supported within the device frame 110. In embodiments, the opening 108 aligns with device frame 110 which inserts into an inner side of the outer shell 106. The device frame 110 allows for display 101 to be supported and held within the outer shell 106 of door 102. In embodiments, the display 101 may be a touchscreen device or have a touchscreen interface surface capable of receiving touch inputs.

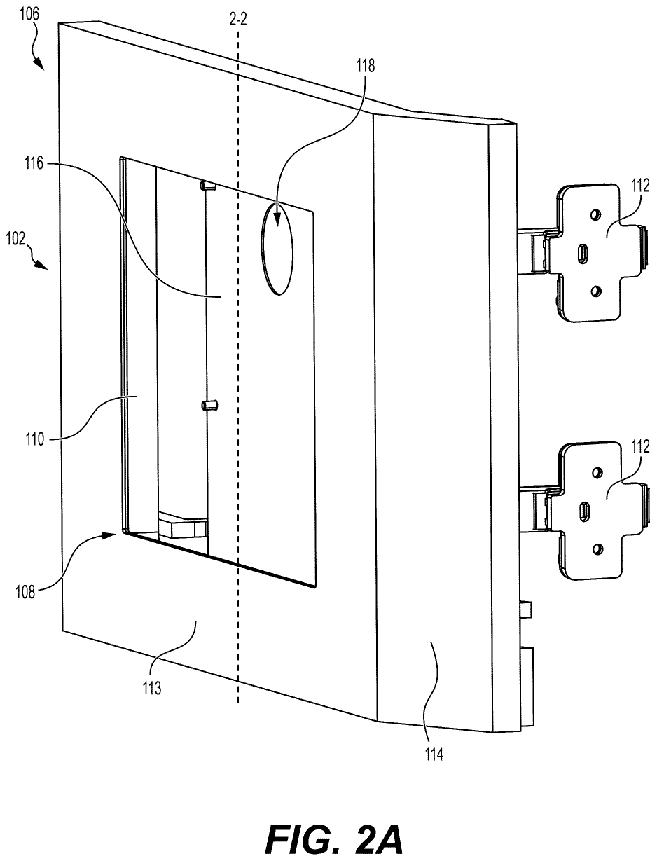

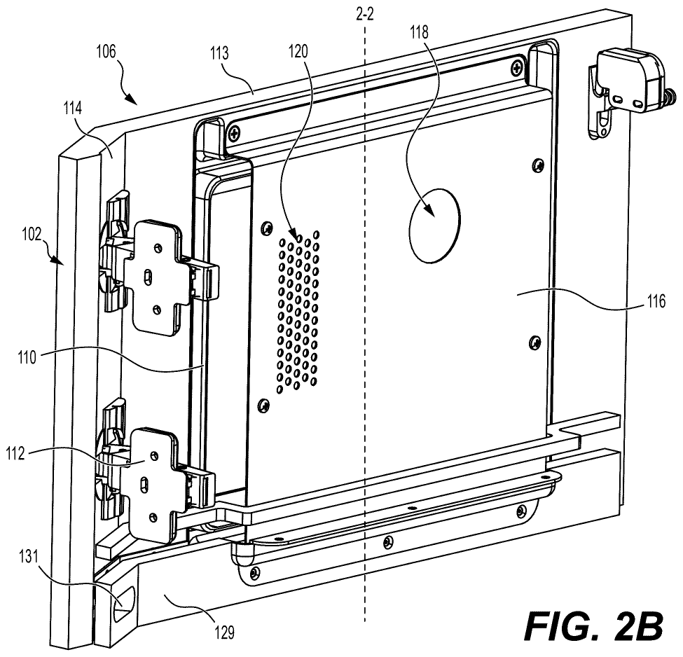

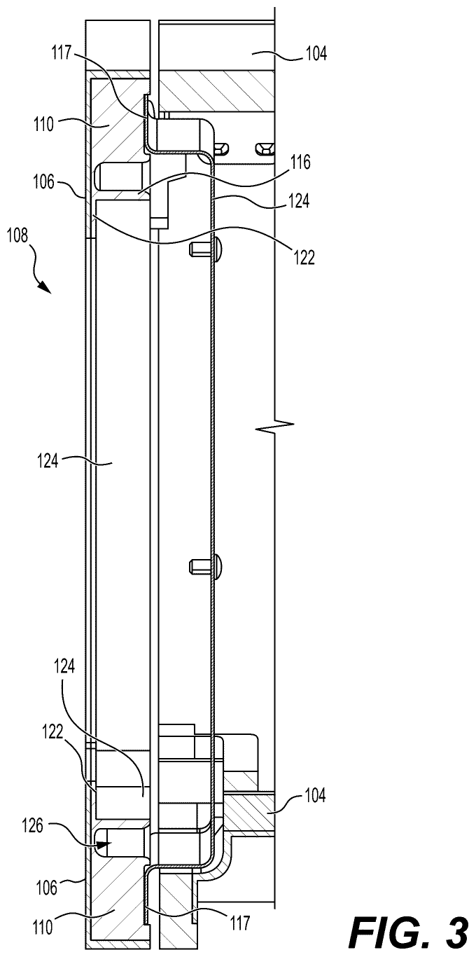

With reference to FIGS. 2A and 2B inner and outer sides of door 102 are shown with door 102 removed from cabinet housing 104. In embodiments, the opening 108 and device frame 110 are positioned substantially in the center of the main portion 113 of outer shell 106. The outer shell 106 has an angled portion 114 which is angled relative to main portion 113 and includes a side edge which abuts the housing 104. In embodiments, hinges 112 are mounted to the inner facing side of angled portion 114 and an inner facing side of housing 104 (not shown in FIGS. 2A and 2B) and allow for the door 102 to be moved to open and closed positions. In embodiments, the hinges 112 may be an overlay type of hinge configured to allow the door 102 to swing open and closed with a greater radius (i.e., a greater swing radius) than is provided with a pivot hinge. The overlay hinge may substantially prevent wiring from the display 101 fed through the outer shell 106 from being pinched or pulled when the door 102 is moved to open or closed positions. A backing panel 116 is configured to mount to an inner side of the device frame 110 and forms the backing of the door 102. With reference to FIGS. 2B and 3, the backing panel 116 includes tabbed ends 117 which fasten backing panel 116 to device frame 110. The tabbed ends 117 are offset from the main body of backing panel 116 such that space is created in between the main body of backing panel 116 and the device frame 110. The backing panel 116 in embodiments is configured to be a heat sink to provide heat dissipation which allows air to circulate in and out of the panel providing temperature regulation for the display 101. With reference to FIG. 2B, backing panel 116 includes a large hole 118 and a plurality of small holes 120. The holes 118 and 120 allow for air to circulate into the backing panel 116 and against the display 101. More specifically, substantially cool surrounding air can pass into the small holes 120 and then to the display 101 to provide cooling to the display 101. Warm air produced by the display 101 and air that has been cycled to the display 101 from plurality of small holes 120 can be outlet through the large hole 118. In this way the display 101 can be substantially prevented from overheating. In some embodiments, the large hole 118 can be aligned with a fan of the display 101 such that air propelled by the fan is directed out of the backing panel 116 and away from the interface panel. The backing panel 116 can be fabricated from an Aluminum material and may have a high gloss finish such that heat is prevented from substantially impacting the display 101.

FIG. 3 shows a cross section taken along the line 2-2 shown in FIGS. 2A and 2B. The device frame 110 is positioned in between the outer shell 106 and backing panel 116 and substantially inserts into a compartment formed into the outer shell 106. The device frame 110 inserts into the outer shell 106 of door 102 and is configured to hold the display 101 in the door 102. The device frame 110 includes forward portions 122 configured around the opening 108 and form the edges of the device frame 110. The forward portions 122 butt up directly against the inner side of outer shell 106 and extend substantially perpendicular to wall portions 124 which form the walls and sides of the device frame 110. The display 101 is configured to be inserted into the device frame 110 and directly contacts the forward portions 122 and wall portions 124. The display 101 is prevented from falling out of cabinet 100 by forward portions 122 which press up directly against the display 101. The forward portions 122 and wall portions 124 support and hold the display 101 in place. In embodiments, the outer shell 106 is substantially thin which allows for the display 101 screen to be pressed up directly against the forward portions 122 which directly contact the outer shell 106. In this way, the display 101 is sandwiched in between the outer shell 106 and backing panel 116. This can be advantageous for preserving space in cabinet 100 and substantially flush mounting the display 101 with the outer shell 106. In embodiments, the device frame 110 includes a channel 126 formed into an inner facing side of the frame beneath the bottommost wall portion 124. The channel 126 is horseshoe shaped with the opening being directed out of the device frame 110 towards the backing panel 116. In embodiments, wiring of the display 101 in device frame 110 can be received into the channel 126. The offset of the backing panel 116 from the tabbed ends 117 allows for the wiring to travel from the display 101 to the channel 126. In this way the channel 126 acts as an entrance for the wiring.

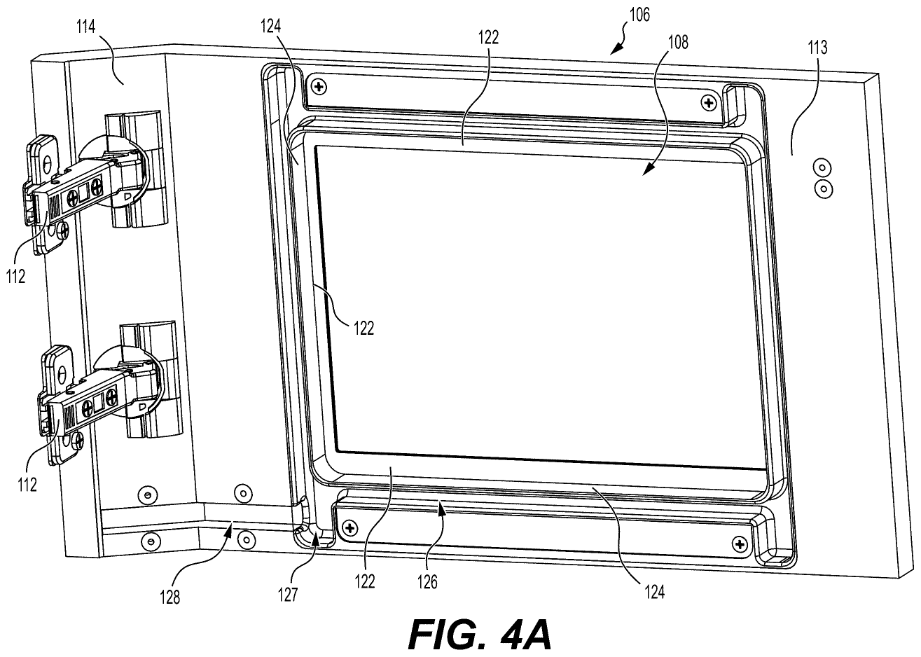

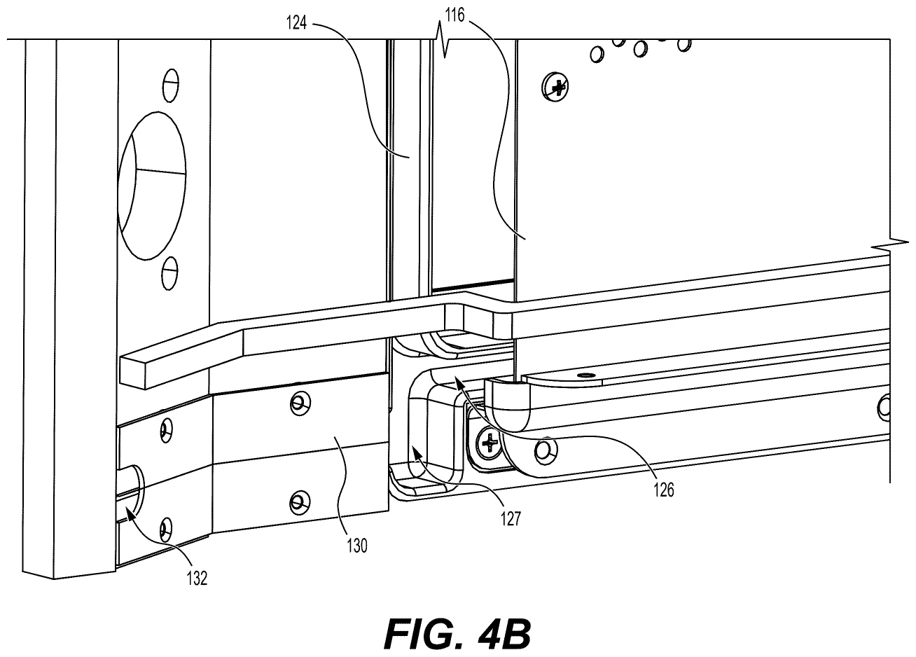

With reference to FIGS. 4A and 4B, the channel 126 extends beneath the wall portions 124 and connects to a channel 128 formed into the main wall and angled portion 114 of outer shell 106. Channel 128 includes a straight portion formed into the main portion 113 of door 102 and an angled portion formed into the angled portion 114 of door 102. In embodiments, the channel 126 has a drop-down portion 127 which drops down to connect channel 126 to the straight portion of channel 128. In this way, wiring from the display 101 can be received into the channel 126 and then carried into the channel 128. This creates a path for wiring to be fed from the display 101 held in door 102 out of the door 102 and away from the display 101 such that the display 101 can be connected to the aircraft and aircraft systems. With reference to FIG. 4B, a cover plate 130 is configured to mount to the outer shell 106 and covers the channel 128. The cover plate 130 has a straight portion and an angled portion configured to cover the straight portion and angled portion of channel 128 and match the angle of angled portion 114 relative to main portion 113. An end of cover plate 130 includes a slot 132. The slot 132 is positioned at an end of cover plate 130 which aligns with the end of channel 128. Slot 132 allows for wiring in channel 128 to exit out of channel 128 and out of the door 102 and housing 104. When wiring is fed through the channels 126 and 128, the wiring can be kept substantially free and loose and may not be required to be zip tied or adhered to the channel walls due to the cover plate 130. Advantageously, when the door 102 is opened and closed, the slack and looseness of the wiring in channel 128 allows for the door 102 to open and close freely without damaging any of the wiring. In some embodiments, with reference to FIG. 2B, a structural bracket 129 may be positioned on top of the cover plate 130 and drop-down portion 127. The structural bracket 129 can include a slot 131 which aligns with the slot 132 to allow wiring to exit from channel 128 and out of door 102.

FIGS. 5A and 5B show door 102 in an open position relative to housing 104. The angled portion 114 pivots substantially perpendicular to the housing 104. The hinges 112 allow for the door 102 to pivot open and the channels 126 and 128 allow for the device wiring to be carried out of door 102 and away from the display 101. In embodiments, angled portion 114 increases the bend radius of the door relative to housing 104. This allows for the wiring in channel 128 to have less bend and bend more gradually when the door 102 is opened which may increase the lifespan of the wiring and prevent damage from consistent opening and closing of door 102. The cover plate 130 allows for the wiring to be contained in the channel 128 when the door 102 opens and closes and allows for the wiring to be loose and unrestricted in channel 128. The looseness of wiring prevents the door 102 from being restricted when being opened and closed and prevents pulling or tension in the wires when the door 102 is opened and closed.

Many different arrangements of the various components depicted, as well as components not shown, are possible without departing from the spirit and scope of what is claimed herein. Embodiments have been described with the intent to be illustrative rather than restrictive. Alternative embodiments will become apparent to those skilled in the art that do not depart from what is disclosed. A skilled artisan may develop alternative means of implementing the aforementioned improvements without departing from what is claimed.

It will be understood that certain features and subcombinations are of utility and may be employed without reference to other features and subcombinations and are contemplated within the scope of the claims. Not all steps listed in the various figures need be carried out in the specific order described.

1. An integrated display device cabinet door comprising:
an outer shell comprising an opening configured to reveal a display, wherein the outer shell is configured to pivot relative to a cabinet housing;
a device frame configured to insert into the outer shell and support the display in the outer shell, wherein the device frame is configured to align the display within the opening; and
a channel formed into the outer shell, wherein the channel is configured to receive wiring from the display and provide a path for the wiring to exit out of the outer shell.

2. The cabinet door of claim 1, comprising a backing panel configured to provide a backing for the cabinet door.

3. The cabinet door of claim 2, wherein the backing panel includes an outlet hole substantially aligned with an air outlet of the display, wherein the outlet hole allows air exchange through the backing panel.

4. The cabinet door of claim 1, wherein the outer shell includes a main portion and an angled portion which is angled relative to the main portion.

5. The cabinet door of claim 4, wherein the channel is formed into the main portion and the angled portion of the outer shell, and a portion of the channel is angled to match the angle of the angled portion.

6. The cabinet door of claim 4, wherein the angled portion of the channel is configured to increase a bend radius of the cabinet door relative to the cabinet housing thereby mitigating damage to the wiring by allowing the wiring to be bent gradually when the cabinet door is opened and closed.

7. The cabinet door of claim 4, comprising a cover plate mounted to the angled portion and configured to cover the opening of the channel.

8. The cabinet door of claim 7, wherein the cover plate includes a slot, the slot being configured to receive the wiring for exiting the channel.

9. The cabinet door of claim 1, comprising hinges mounted to the outer shell and the cabinet housing, wherein the hinges are configured to allow the cabinet door to open and close relative to the cabinet housing.

10. The cabinet door of claim 9, wherein the hinges are an overlay type of hinge configured to increase a swing radius when the cabinet door is opened and closed.

11. An integrated display device cabinet door comprising:
a cabinet door having an outer shell configured to form an outer structure of the cabinet door, wherein the outer shell comprises:
a device frame configured to support a display, wherein the device frame comprises an opening positioned to align with the display when supported in the device frame; and
a backing panel, wherein the device frame is sandwiched between the backing panel and an inner portion of the outer shell;
a cover plate configured to cover a channel formed in the outer shell, wherein the channel comprises an entrance positioned near the device frame and an exit positioned away from the device frame, such that wiring from the display is received by the channel and routed away from the display and out of the outer shell.

12. The cabinet door of claim 11, wherein the backing panel includes tabbed ends having an offset from a main body of the backing panel, wherein the tabbed ends are configured to fasten to the device frame.

13. The cabinet door of claim 12, wherein the offset of the tabbed ends allows for the main body to be spaced away from the display such that the channel is configured to receive the wiring.

14. The cabinet door of claim 11, wherein the outer shell comprises an outer wall and the display is pressed up directly against the outer wall when supported by the device frame, such that the display is substantially flush mounted with the outer shell.

15. The cabinet door of claim 11, wherein the backing panel includes a plurality of inlet holes which allow for air to circulate against the display behind the backing panel.

16. The cabinet door of claim 11, wherein the display is a user interface device.

17. The cabinet door of claim 16, wherein the user interface device is a touchscreen interface.

18. The cabinet door of claim 11, wherein the device frame includes a forward portion and a wall portion configured to contact the display and support the display within the device frame.

19. The cabinet door of claim 11, wherein the cover plate includes a slot configured for the wiring to exit the channel.

20. The cabinet door of claim 11, comprising a structural bracket positioned against an outer surface of the cover plate, wherein the structural bracket has an outer slot which aligns with the slot of the cover plate.
